(19) United States
(12) Patent Application Publication
(10) Pub. No.: US 2011/0202842 A1
(43) Pub. Date: Aug. 18, 2011

(54) SYSTEM AND METHOD OF CREATING CUSTOM MEDIA PLAYER INTERFACE FOR SPEECH GENERATION DEVICE

(75) Inventors: BRENT MICHAEL WEATHERLY, PITTSBURGH, PA (US); PIERRIE JEAN MUSICK, PITTSBURGH, PA (US)

(73) Assignee: DYNAVOX SYSTEMS, LLC, Pittsburgh, PA (US)

(21) Appl. No.: 12/704,821

(22) Filed: Feb. 12, 2010

(51) Int. Cl. G06F 3/048; G06F 3/01

(52) U.S. Cl. 715/716; 715/765

(57) ABSTRACT

Systems and methods of providing electronic features for creating a customized media player interface for an electronic device include providing a graphical user interface design area having a plurality of display elements. Electronic input signals then may define for association with selected display elements one or more electronic actions relative to the initiation and control of media files accessible by the electronic device (e.g., playing, pausing, stopping, adjusting play speed, adjusting volume, adjusting current file position, toggling modes such as repeat or shuffle, and/or establishing, viewing and/or clearing a playlist.) Additional electronic input signals may define for association with selected display elements labels such as action identification labels or media status labels. A graphical user interface is then initiated on an electronic display associated with an electronic device, wherein the graphical user interface comprises media player features corresponding to the plurality of display elements and associated electronic actions and/or labels.

### CROSS-REFERENCE TO RELATED APPLICATIONS

N/A

### STATEMENT REGARDING FEDERALLY SPONSORED RESEARCH OR DEVELOPMENT

N/A

### BACKGROUND

The presently disclosed technology generally pertains to systems and methods for providing alternative and augmentative (AAC) steps and features such as may be available in a speech generation device or other electronic device.

Electronic devices such as speech generation devices (SGDs) or Alternative and Augmentative Communication (AAC) devices can include a variety of features to assist with a user's communication. Such devices are becoming increasingly advantageous for use by people suffering from various debilitating physical conditions, whether resulting from disease or injuries that may prevent or inhibit an afflicted person from audibly communicating. For example, many individuals may experience speech and learning challenges as a result of pre-existing or developed conditions such as autism, ALS, cerebral palsy, stroke, brain injury and others. In addition, accidents or injuries suffered during armed combat, whether by domestic police officers or by soldiers engaged in battle zones in foreign theaters, are swelling the population of potential users. Persons lacking the ability to communicate audibly can compensate for this deficiency by the use of speech generation devices.

In general, a speech generation device may include an electronic interface with specialized software configured to permit the creation and manipulation of digital messages that can be translated into audio speech output or other outgoing communication such as a text message, phone call, e-mail or the like. Messages and other communication generated, analyzed and/or relayed via an SGD or AAC device may often include symbols and/or text alone or in some combination. In one example, messages may be composed by a user by selection of buttons, each button corresponding to a graphical user interface element composed of some combination of text and/or graphics to identify the text or language element for selection by a user.

Current advancements for speech generation devices have afforded even more integrated functionality for their users. For example, some SGDs or other AAC devices are configured not only for providing speech-based output but also for playing media files (e.g., music, video, etc.), providing access to the Internet, and/or even making telephone calls using the device.

For some of the advanced SGD functions, especially playing media files, the existing interfaces available on an SGD are fixed. Such pre-defined interfaces may typically be limited in the way they coordinate user selection and integration of the various SGD functionality. Such limitation may raise issues for users interfacing with an SGD in particular access modes, such as but not limited to eye tracking, audio scanning, or others. In addition, users do not have the option to modify such interfaces to customize various aspects thereof. This can provide potential limitations on the accessibility, efficiency, convenience and desirability of an SGD.

In light of the specialized utility of speech generation devices and related interfaces for users having various levels of potential disabilities, a need continues to exist for refinements and improvements to media player interfaces for such devices. While various implementations of speech generation devices and associated media features have been developed, no design has emerged that is known to generally encompass all of the desired characteristics hereafter presented in accordance with aspects of the subject technology.

### BRIEF SUMMARY

In general, the present subject matter is directed to various exemplary speech generation devices (SGDs) or other electronic devices having improved configurations for providing selected AAC features and functions to a user. More specifically, the present subject matter provides improved features and steps for creating a customized media player interface for an electronic device.

In one exemplary embodiment, a method of providing electronic features for creating a customized media player interface for an electronic device includes a step of electronically displaying a media player interface design area to a user. A plurality of display elements are placed within the media player interface design area. In response to one or more electronic input signals from a user, selected ones of the plurality of display elements are associated with one or more electronic actions relative to the electronic initiation and control of media files accessible by the electronic device. A media player interface is then initiated on an electronic display apparatus associated with the electronic device, wherein the media player interface comprises media player features corresponding to the plurality of display elements and associated electronic actions.

In some more particular exemplary embodiments, one or more electronic input signals from a user define one or more of the number of buttons to be placed within the media player interface design area, the size of the buttons to be placed within the media player interface design area, and the relative location of the buttons within the media player interface design area. Still further, the one or more given actions relative to electronic initiation and control of media files that may be associated with selected of the plurality of display elements may comprise one or more of playing, pausing, stopping, adjusting play speed, adjusting volume, adjusting current file position, toggling modes such as repeat and shuffle, establishing a playlist, viewing a playlist, modifying a playlist, clearing a playlist. Display elements also may be associated with one or more given electronic actions relative to the communication of speech-generated message output provided by the electronic device.

In other more particular exemplary embodiments, labels also may be associated with selected ones of the plurality of display elements. Selected labels may correspond to one or more of symbols and text describing the actions associated with each display element. Selected labels may correspond to media status labels that identify certain aspects of media file action status, including one or more of a current media file label, current playlist label, media playing status, media shuffle status, and media repeat status.

In still other more particular exemplary embodiments, electronic input signals may define how to configure the electronic device for playing the audio portion of media files when other audio signals are also provided as output, how to configure the electronic device for editing existing playlist files when new files are added to an existing playlist, and/or specific levels for volume settings associated with the playback of speech signals, audio feedback signals, and media signals.

It should be appreciated that still further exemplary embodiments of the subject technology concern hardware and software features of an electronic device configured to perform various steps as outlined above. For example, one exemplary embodiment concerns a computer readable medium embodying computer readable and executable instructions configured to control a processing device to implement the various steps described above or other combinations of steps as described herein.

In one particular exemplary embodiment, a computer readable medium includes computer readable and executable instructions configured to control a processing device to: electronically display a graphical user interface design area to a user, wherein a plurality of display elements are placed within the graphical user interface design area; in response to one or more electronic input signals from a user, associate selected of the plurality of display elements with one or more given electronic actions relative to the electronic initiation and control of media files accessible by the electronic device; in response to one or more additional electronic input signals, associate one or more labels with selected ones of the plurality of display elements; and initiate a graphical user interface on an electronic display apparatus associated with the electronic device, wherein said graphical user interface comprises media player features corresponding to the plurality of display elements and associated electronic actions.

In a still further example, another embodiment of the disclosed technology concerns an electronic device, such as but not limited to a speech generation device, including such hardware components as at least one electronic input device, at least one electronic output device, at least one processing device and at least one memory. The at least one electronic output device can be configured to display a graphical user interface design area to a user, wherein a plurality of display elements are placed within the graphical user interface design area. The at least one electronic input device can be configured to receive electronic input from a user corresponding to data for defining one or more of the number of display elements to be placed within the graphical user interface design area, the size of the display elements to be placed within the graphical user interface design area, the relative location of the display elements within the graphical user interface design area, one or more electronic actions relative to the electronic initiation and control of media files accessible by the electronic device for association with selected display elements, and one or more action identification labels or media status labels for association with selected display elements. The at least one memory may comprise computer-readable instructions for execution by said at least one processing device, wherein said at least one processing device is configured to receive the electronic input defining the various features of the graphical user interface and to initiate a graphical user interface having such features.

In more particular exemplary embodiments of an electronic device, the electronic device may comprise a speech generation device that comprises at least one speaker for providing audio output. In such embodiments, the at least one processing device can be further configured to associate selected ones of the plurality of display elements with one or more given electronic actions relative to the communication of speech-generated message output provided by the electronic device.

In other more particular exemplary embodiments of an electronic device, the one or more given actions relative to electronic initiation and control of media files that may be associated with selected of the plurality of display elements comprises one or more of playing, pausing, stopping, adjusting play speed, adjusting volume, adjusting current file position, toggling modes such as repeat and shuffle, establishing a playlist, viewing a playlist, modifying a playlist, and clearing a playlist.

In still other more particular exemplary embodiments of an electronic device, the at least one processing device is further configured to operate the electronic device in accordance with additional input signals received from a user defining one or more of the following: how to configure the electronic device for playing the audio portion of media files when other audio signals are also provided as output, how to configure the electronic device for editing existing playlist files when new files are added to an existing playlist, and specific levels for volume settings associated with the playback of speech signals, audio feedback signals, and media signals.

Additional aspects and advantages of the disclosed technology will be set forth in part in the description that follows, and in part will be obvious from the description, or may be learned by practice of the technology. The various aspects and advantages of the present technology may be realized and attained by means of the instrumentalities and combinations particularly pointed out in the present application.

### BRIEF DESCRIPTION OF THE DRAWINGS

The accompanying drawings, which are incorporated in and constitute a part of this specification, illustrate one or more embodiments of the presently disclosed subject matter. These drawings, together with the description, serve to explain the principles of the disclosed technology but by no means are intended to be exhaustive of all of the possible manifestations of the present technology.

FIG. 1 provides a flow chart of exemplary steps in a method of providing electronic features for creating a customized media player interface for an electronic device;

FIG. 2 depicts a first exemplary embodiment of a graphical user interface area with a plurality of display elements in accordance with aspects of the presently disclosed technology;

FIG. 3 depicts a second exemplary embodiment of a graphical user interface area with a plurality of display elements in accordance with aspects of the presently disclosed technology;

FIG. 4 depicts an exemplary embodiment of a graphical user interface menu for selecting music/media settings in accordance with aspects of the present technology; and

FIG. 5 provides a schematic view of exemplary hardware components for use in an exemplary speech generation device having media player features in accordance with aspects of the presently disclosed technology.

### DETAILED DESCRIPTION OF THE PREFERRED EMBODIMENTS

Reference now will be made in detail to the presently preferred embodiments of the disclosed technology, one or more examples of which are illustrated in the accompanying drawings. Each example is provided by way of explanation of the technology, which is not restricted to the specifics of the examples. In fact, it will be apparent to those skilled in the art that various modifications and variations can be made in the present subject matter without departing from the scope or spirit thereof. For instance, features illustrated or described as part of one embodiment, can be used on another embodiment to yield a still further embodiment. Thus, it is intended that the presently disclosed technology cover such modifications and variations as may be practiced by one of ordinary skill in the art after evaluating the present disclosure. The same numerals are assigned to the same or similar components throughout the drawings and description.

The technology discussed herein makes reference to processors, servers, memories, databases, software applications, and/or other computer-based systems, as well as actions taken and information sent to and from such systems. The various computer systems discussed herein are not limited to any particular hardware architecture or configuration. Embodiments of the methods and systems set forth herein may be implemented by one or more general-purpose or customized computing devices adapted in any suitable manner to provide desired functionality. The device(s) may be adapted to provide additional functionality, either complementary or unrelated to the present subject matter. For instance, one or more computing devices may be adapted to provide desired functionality by accessing software instructions rendered in a computer-readable form. When software is used, any suitable programming, scripting, or other type of language or combinations of languages may be used to implement the teachings contained herein. However, software need not be used exclusively, or at all. For example, as will be understood by those of ordinary skill in the art without required additional detailed discussion, some embodiments of the methods and systems set forth and disclosed herein also may be implemented by hard-wired logic or other circuitry, including, but not limited to application-specific circuits. Of course, various combinations of computer-executed software and hard-wired logic or other circuitry may be suitable, as well.

It is to be understood by those of ordinary skill in the art that embodiments of the methods disclosed herein may be executed by one or more suitable computing devices that render the device(s) operative to implement such methods. As noted above, such devices may access one or more computer-readable media that embody computer-readable instructions which, when executed by at least one computer, cause the at least one computer to implement one or more embodiments of the methods of the present subject matter. Any suitable computer-readable medium or media may be used to implement or practice the presently-disclosed subject matter, including, but not limited to, diskettes, drives, and other magnetic-based storage media, optical storage media, including disks (including CD-ROMS, DVD-ROMS, and variants thereof), flash, RAM, ROM, and other solid-state memory devices, and the like.

Referring now to the drawings, various aspects of a system and method of providing electronic features for creating a customized media player interface for an electronic device are disclosed. In general, the subject technology provides features by which a user can create a media player interface (e.g., an MP3 player or interface to play other music, video, picture or other media files). Instead of being limited to a pre-defined media player interface as available in known devices, features for providing a custom interface allow users to incorporate whatever buttons, symbols, sizes, colors, language, labels, related actions or other functionality or features desired for initiating and controlling media files accessible by an electronic device. By delivering complete control of a media player interface design, electronic devices such as speech generation devices can become more functionally adaptable for users implementing a variety of different access methods (e.g., touch screen, joystick, mouse pause, eye tracking, and the like).

The ability to accommodate customized designs for media playing functionality in user interfaces for an electronic device provides a variety of advantages. For example, interfaces can be created having arbitrarily sized buttons and collections of functions to accommodate user preferences and access abilities. Media playing buttons and associated functionality can also be integrated with other basic functionality of a speech generation device, such as buttons for generating, relaying and/or otherwise coordinating the communication of speech-generated message outputs provided by a device. In addition, a variety of media action functions can be integrated in custom arrangements. Examples of actions that may be linked to various display elements in a custom interface include playing, pausing, stopping, adjusting play speed, adjusting volume, adjusting current file position, toggling modes such as repeat and shuffle, establishing a playlist, viewing a playlist, modifying a playlist, clearing a playlist, etc.

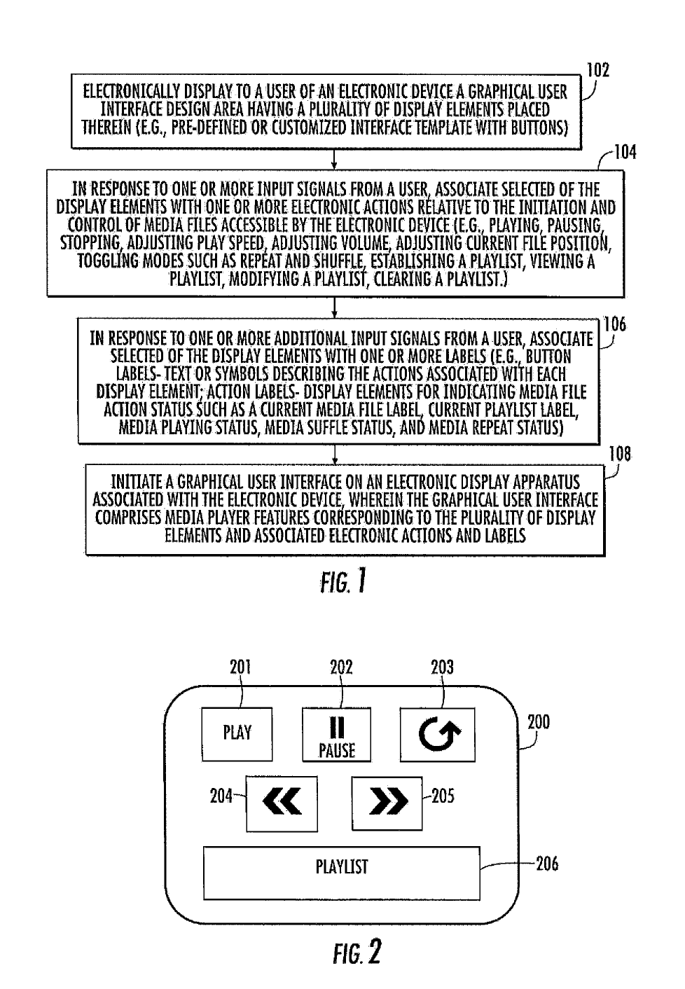

FIG. 1 provides a schematic overview of an exemplary method of providing electronic features for creating a custom media player interface for an electronic device. The steps provided in FIG. 1 may be performed in the order shown in such figure or may be modified in part, for example to exclude optional steps or to perform steps in a different order than shown in FIG. 1.

The steps shown in FIG. 1 are part of an electronically-implemented computer-based algorithm. Computerized processing of electronic data in a manner as set forth in FIG. 1 may be performed by a special-purpose machine corresponding to some computer processing device configured to implement such algorithm. Additional details regarding the hardware provided for implementing such computer-based algorithm are provided in FIG. 5.

A first exemplary step 102 is to electronically display to a user of an electronic device a graphical user interface design area having a plurality of display elements placed therein. The graphical user interface design area (i.e., the media player interface design area) is the basic framework in which a user can design and customize a media player interface. As such, at least some of the display elements within such interface design area are customizable by a user by selecting various actions and labels to accompany such display elements. The basic framework of the graphical user interface design area (e.g., the size and shape of the interface, the number of display elements, the size and shape of the display elements and placement location within the interface) may be either pre-defined or customized by a user. When one or more of such aspects are pre-defined, they may be part of an existing interface having open room for customizable buttons or other display elements. Alternatively, it is possible in one embodiment for a user to create from scratch every aspect of a custom media interface, including the basic framework associated with the interface design area and display elements.

Referring again to FIG. 1, a second exemplary step 104 in a method of providing electronic features for creating a custom media player interface for an electronic device involves associating actions with selected display elements in the graphical user interface design area. The association, or linking, of electronic actions to display elements will ultimately result in the ability for a user to select a display element on an output device (e.g., a touchscreen or other interactive display) for selection by a user (e.g., via an input device, such as a mouse, keyboard, touchscreen, eye gaze controller, virtual keypad or the like). When selected, the user input features can trigger control signals that can be relayed to the central computing device within an SGD to perform an action in accordance with the selection of the user buttons. Such additional actions may result in execution of additional instructions, display of new or different user interface elements, or other actions as desired and defined by a user in step 104.

A variety of different actions may be associated with the display elements as defined by a user in step 104. For example, at least one of the display elements in accordance with aspects of the presently disclosed technology is configured to initiate and/or control media files (e.g., music, video, graphics or the like) accessible by the electronic device. Media initiation and control actions include but are not limited to playing, pausing, stopping, adjusting play speed, adjusting volume, adjusting current file position, toggling modes such as repeat and shuffle, establishing a playlist, viewing a playlist, modifying a playlist, clearing a playlist. Specific details regarding the above actions and others that may be associated with display elements for a media player interface are presented in Table 1 below.

TABLE 1
Actions for Display Elements in a Media Player Interface

| | |
|---|---|
| Browse for | Search through the folders on an electronic device (or a |
| Music Folder | connected USB flash drive or other peripheral or networked |
| | storage location) and select a folder that contains music files. |
| Change | Adjust the rate of the music file that is currently playing. You can |
| Playback | select a specific speed (Slow, Medium, or Fast), or choose to |
| Rate | increase or decrease the playback speed when you program the |
| | button. |
| Change | Cycle through the repeat options: repeat one song, repeat the |
| Repeat Mode | entire playlist, or turn repeat off. |
| Clear Playlist | Clear the current playlist. |
| Fast Forward | Advance through the currently playing music file at a speed |
| | faster than at which it would normally play. You can specify the |
| | fast forward rate (Slow, Medium, or Fast) when you program the |
| | button. |
| Music | Open the Music Settings menu to adjust such aspects as how to |
| Settings | configure the electronic device for playing the audio portion of |
| | media files when other audio signals are also provided as |
| | output, how to configure the electronic device for editing existing |
| | playlist files when new files are added to the existing playlist, |
| | and defining specific levels for volume settings associated with |
| | the playback of speech signals, audio feedback signals, and |
| | media signals. |
| Music | Decrease the volume of the music. (This will not affect the |
| Volume Down | speech volume). |
| Music | Increase the volume of the music. (This will not affect the |
| Volume Up | speech volume). |
| Next Song | Play the next song in the current playlist. |
| Play a | Queue up a single song file. You can add this behavior multiple |
| Music File | times to one button to create a playlist. |
| Play Music | Play all of the music files in a specified folder. You must select |
| from Folder | the folder when you program the button with the behavior. |
| Play/Pause/ | Cycle between the three states of a music file: playing, paused, |
| Resume | or resume play. |
| Previous Song | Play the previous song in the playlist. |
| Repeat One Song | Repeat the current song in the playlist. |
| Repeat Playlist | Repeat the entire current playlist. |
| Rewind | Rewind through the currently playing music file at a speed |
| | faster than at which it would normally play. You can specify |
| | the rewind rate (Slow, Medium, or Fast) when you program |
| | the button |
| Stop | Stop the currently playing song. Once this behavior is used, |
| | the song will play again from the beginning. (To start the song |
| | playing from the point at which it was stopped, use the Play/ |
| | Pause/Resume behavior.) |
| Toggle Shuffle | Play the music files in the current playlist in random order. To |
| | turn off the shuffle and play the current playlist in order, |
| | simply select the button again. |

The display elements within a graphical user interface design area also may be linked to actions related to the communication of a composed message as “spoken” audio output, or relay as a text message, phone call, e-mail or other outgoing communication. Exemplary linked actions in accordance with such basic functionality of a speech generation device include one or more of speaking a message (i.e., making the button speak the message entered by a user using a synthesized computer voice, recorded voice or combination of sounds), typing a message (i.e., placing a message entered by the user into the message display), reading with highlighting (i.e., reading and highlighting the symbols and text on the face of a symbolate button), playing a recorded message (i.e., playing a message recorded by a user or a selected saved sound), changing a board to a new selected board or to a previously selected board, providing a text preview (i.e., displaying a text cue for the button's function when a pointer is placed over the button), providing a spoken preview (i.e., playing a synthesized voice cue for the button's function when a pointer is placed over the button), providing a recorded preview (i.e., playing a recorded cue for the button's function when a pointer is placed over the button), clearing the contents of the message display if a message display is present on the board, and/or providing a picture button (i.e., placing the symbol and/or graphic on the face of a button into the message display if a message display is present on the board). A user may implement such actions as making a button play a recorded message, giving a button a spoken preview, adding a preview display, editing a button's assigned actions, making a button speak, making a button play a saved sound, giving a button a recorded preview, and/or changing a button's text preview.

Referring more to FIG. 1, another step 106 that may be implemented in a method of providing electronic features for creating a custom media player interface for an electronic device corresponds to associating one or more of a variety of different labels with the display elements in a graphical user interface design area. In some examples, action identification labels are provided as graphic identifying features for a display element. Action identification labels may include such items as text, icons, symbols and/or media previews (e.g., music, picture or video thumbnails or segments) that are used to describe or otherwise identify the display elements with which they are associated. In particular, action identification labels may serve to describe the action that is also associated with a given display element.

Another example of labels that may be associated with selected display elements in a media player interface correspond to media status labels. In general, media status labels correspond to display elements that have associated labels but not associated actions, wherein the labels are used to visually represent certain aspects of the status of current media file action in a media player. For example, exemplary media file action status options may include, but are not limited to, a current media file label (e.g., Current Song—displays the filename of the song or other media file that is currently being played or is paused), current playlist label (e.g., Current Playlist—displays the current playlist, with the song name currently playing/paused in a different color than other songs or media elements on the playlist), media playing status (e.g., Music Playing Status—displays the status of the current song—“playing,” “paused,” or “stopped” or associated symbols/icons), media shuffle status (e.g., Music Shuffle Status—displays the current state of the shuffle feature—“shuffle on” or “shuffle off” or associated symbols/icons), and media repeat status (e.g., Music Repeat Status—displays the current state of the repeat feature—“repeat one,” “repeat all,” or “repeat none.”)

Another example of media status labels corresponds to icons that may be placed in an interface (e.g., on a portion of a title bar or other designated location) that appear to provide an indication to a user of the status of the music file that is currently playing on the electronic device. For example, title bar music icons may include selected combinations of one or more of the following examples: a play icon to indicate that the song is currently playing, a pause icon to indicate that the song is currently paused, a fast forward icon to indicate that the song is advancing at a speed rate faster than the regular playing speed, a rewind icon to indicate that the song is moving backwards at a speed faster than the regular playing speed, a shuffle icon to indicate that the song(s) in the playlist will be played in random order, a repeat one song icon to indicate that the current song will be repeated, and a repeat playlist icon to indicate that the entire playlist will be repeated.

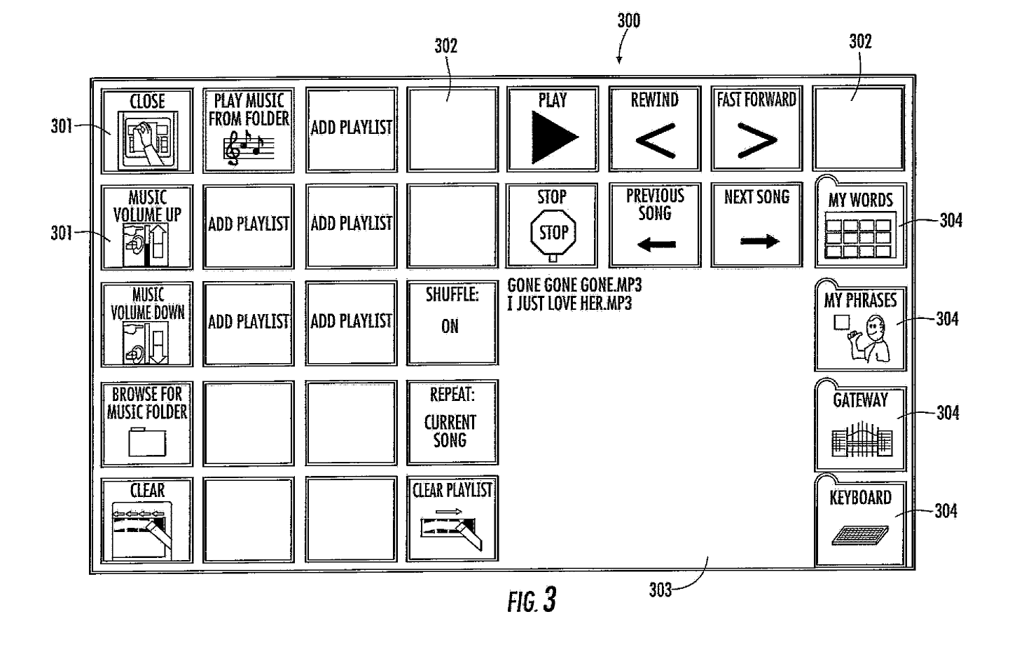

An example of the different types of labels that may be associated with various display elements is presented in FIG. 2. FIG. 2 illustrates an exemplary graphical user interface design area 200 having a plurality of display elements 201-206, respectively. Each of the display elements 201-205 corresponds to a button-type display element having an associated action as well as an associated label, and display element 206 has an associated media status label. For example, display element 201 has an associated text label “PLAY” and is also linked to an action such that user selection of the button will trigger a control signal to play a song file in a playlist. Display element 202 has an associated text label “PAUSE” as well as an associated symbol label as shown. In addition, display element 202 is linked to an action such that user selection of the button will trigger a control signal to pause a song file in a playlist. Display element 203 has an associated symbol label as shown (intended to represent the Replay function) and is linked to an action wherein user selection of the button will trigger a media player to repeat the current playlist. Display elements 204 and 205 include respective symbol labels identifying the Previous Song and Next Song functions. Such elements 204 and 205 are also linked to actions whereby user selection of such buttons will trigger a media player to play the previous song in the playlist or play the next song in the playlist. Display element 206 has an associated media status label, which defines what type of media status information will be displayed in element 206 after the graphical user interface with media player features is designed and actually becomes initiated and active on an electronic device. In the example of FIG. 2, display element 206 has a media status label corresponding to the Playlist such that the current songs in the playlist will be displayed in the area defined by display element 206.

Referring again to FIG. 1, a final step 108 in the method of providing electronic features for creating a custom media player interface for an electronic device corresponds to initiating a graphical user interface on an electronic display apparatus associated with an electronic device. Step 108 basically corresponds to putting the designed media player interface including display elements and associated actions and labels into effect on an electronic device.

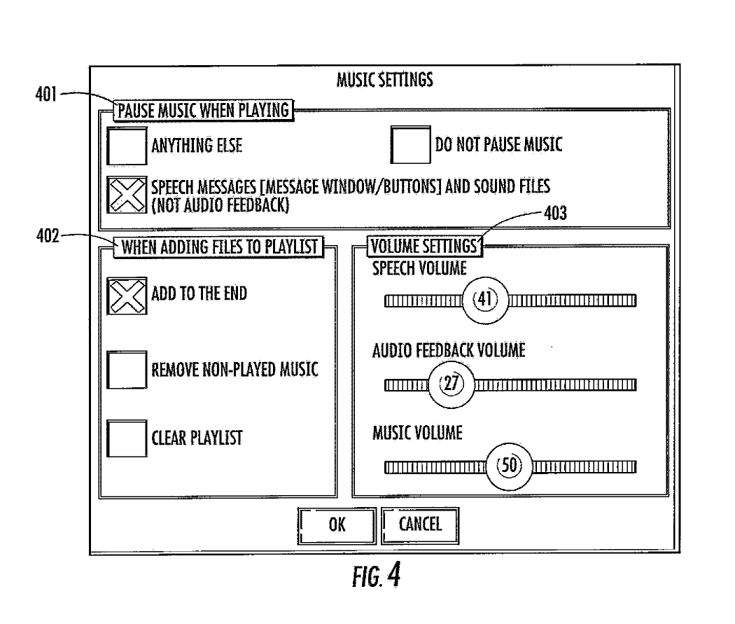

An example of an initiated and active graphical user interface 300 is shown in FIG. 3. The graphical user interface 300 includes several media player display elements 301 having associated actions and action identification labels as previously described. Several additional blank display elements 302 remain configured but are not associated with actions or labels. It is possible for a user to further customize the graphical user interface 300 using the techniques described herein to further enhance the blank display elements 302. Display element 303 corresponds to a display element having a media status label such as a “Current Playlist” status such that all songs in the current playlist are shown in the display element 303. Such playlist may be configured such that the current song being played within the playlist is also provided with a separate identifier, such as being highlighted or shown in a different color than other songs in the list.

With further reference to FIG. 3, speech display elements 304 include actions and associated labels for basic functions of a speech generation device. First and second exemplary speech display elements 304 having labels for “MyWords” and “MyPhrases” may have associated actions that trigger display of selectable words or phrases that may be chosen by a user for inclusion in a spoken or otherwise communicated message on the electronic device. Exemplary speech display element 304 having a “Gateway” label may have an associated action for electronically displaying to the user a further graphical user interface that shows different additional elements to which the user may be linked. Exemplary speech display element 304 having a “Keyboard” label may have an associated action for electronically displaying to the user a further graphical user interface having selectable alphanumeric buttons in a keypad arrangement. Users may use the words, keypad and other linked elements to compose messages for speech output or relayed communication to users, for example, via text message, e-mail or the like.

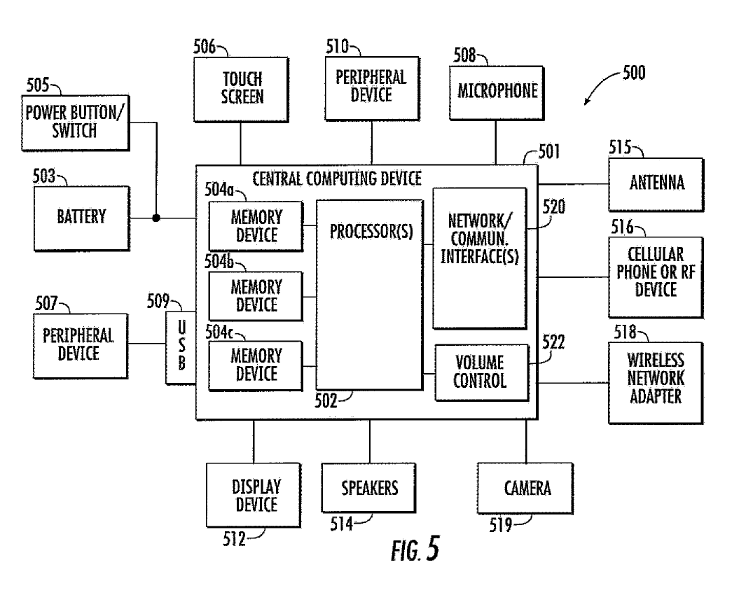

As a further part of the disclosed system and method of providing features for the creation of a custom media player interface, a user also may be able to provide electronic input to configure an electronic device for handling various music settings. As part of a graphical user interface process, a user may be able to select a display element that brings up a music settings interface menu, such as shown in FIG. 4.

In the example of FIG. 4, a user may be able to provide input signals via a first music settings interface portion 401 (i.e., the “Pause Music When Playing” portion) to configure an electronic device for playing the audio portion of media files when other audio signals are also provided as output. For example, in music settings interface portion 401, a user can select check boxes to determine when music should be paused under the following circumstances: (1) Anything Else—When selected, music will be paused when any other sound (spoken text, sound file, etc.) is played; (2) Do Not Pause Music—When selected, music will not be paused when any other sound is played; or (3) Speech Messages (Message Window/Buttons) and Sound Files (no Audio Feedback)—When selected, music will be paused when any speech message (from a button or from the Message Window of a speech generation device) is spoken or another sound file is played. Music will not be interrupted for audio feedback messages.

Referring still to FIG. 4, a user also may be able to provide input signals via a second music settings interface portion 402 (i.e., the “When Adding Files to Playlist” portion) to configure an electronic device for editing existing playlist files when new files are added to the existing playlist. For example, in music settings interface portion 402, a user can select check boxes to manage how music files are added to existing playlists as in the following exemplary options: (1) Add to the End—When selected, new files will be added to the end of the current playlist; (2) Remove Non-Played Music—When selected, each time a new song (or album) is added to the playlist, any songs that have not yet been played get automatically removed from the playlist and the new music gets added to the playlist; or (3) Clear Playlist—When selected, the current playlist is emptied every time a new song (or album) is added to the playlist.

Referring still to FIG. 4, a user also may be able to provide input signals via a third music settings interface portion 403 (i.e. a “Volume Settings” portion) to configure specific levels for volume settings associated with the playback of speech signals, audio feedback signals, and media signals. In one example, multiple sliders are provided to adjust the relative volumes of the speech messages and music played through device speakers. To increase volume, a user may select a slider thumb and drag it to the right. To decrease volume, a user may select a slider thumb and drag it to the left. The speech volume slider may set the speaking volume of the electronic device. The audio feedback volume slider may set the volume of the device audio feedback (if enabled). Audio feedback is important for some access methods, such as audio eye tracking. The music volume slider may set the volume of the music played on the device.

Referring now to FIG. 5, additional details regarding possible hardware components that may be provided to implement the various graphical user interface and media player creation features disclosed herein are provided. FIG. 5 depicts an exemplary electronic device 500, which may correspond to any general electronic device including such components as a computing device 501, at least one input device (e.g., one or more of touch screen 506, microphone 508, peripheral device 510, camera 519 or the like) and one or more output devices (e.g., display device 512, speaker 514, a communication module or the like).

In more specific examples, electronic device 500 may correspond to a stand-alone computer terminal such as a desktop computer, a laptop computer, a netbook computer, a palmtop computer, a speech generation device (SGD) or alternative and augmentative communication (AAC) device, such as but not limited to a device such as offered for sale by DynaVox Mayer-Johnson of Pittsburgh, Pa. including but not limited to the V, Vmax, Xpress, Tango, M³ and/or DynaWrite products, a mobile computing device, a handheld computer, a tablet computer (e.g., Apple's iPad tablet), a mobile phone, a cellular phone, a VoIP phone, a smart phone, a personal digital assistant (PDA), a BLACKBERRY™ device, a TREO™, an iPhone™, an iPod Touch™, a media player, a navigation device, an e-mail device, a game console or other portable electronic device, a combination of any two or more of the above or other electronic devices, or any other suitable component adapted with the features and functionality disclosed herein.

When electronic device 500 corresponds to a speech generation device, the electronic components of device 500 enable the device to transmit and receive messages to assist a user in communicating with others. For example, electronic device 500 may correspond to a particular special-purpose electronic device that permits a user to communicate with others by producing digitized or synthesized speech based on configured messages. Such messages may be preconfigured and/or selected and/or composed by a user within a message window provided as part of the speech generation device user interface. As will be described in more detail below, a variety of physical input devices and software interface features may be provided to facilitate the capture of user input to define what information should be displayed in a message window and ultimately communicated to others as spoken output, text message, phone call, e-mail or other outgoing communication.

Referring more particularly to the exemplary hardware shown in FIG. 5, a computing device 501 is provided to function as the central controller within the electronic device 500 and may generally include such components as at least one memory/media element or database for storing data and software instructions as well as at least one processor. In the particular example of FIG. 5, one or more processor(s) 502 and associated memory/media devices 504a, 504b and 504c are configured to perform a variety of computer-implemented functions (i.e., software-based data services). The one or more processor(s) 502 within computing device 501 may be configured for operation with any predetermined operating systems, such as but not limited to Windows XP, and thus is an open system that is capable of running any application that can be run on Windows XP. Other possible operating systems include BSD UNIX, Darwin (Mac OS X including “Cheetah,” “Leopard,” “Snow Leopard” and other variations), Linux, SunOS (Solaris/OpenSolaris), and Windows NT (XP/Vista/7).

At least one memory/media device (e.g., device 504a in FIG. 5) is dedicated to storing software and/or firmware in the form of computer-readable and executable instructions that will be implemented by the one or more processor(s) 502. Other memory/media devices (e.g., memory/media devices 504b and/or 504c) are used to store data which will also be accessible by the processor(s) 502 and which will be acted on per the software instructions stored in memory/media device 504a. Computing/processing device(s) 502 may be adapted to operate as a special-purpose machine by executing the software instructions rendered in a computer-readable form stored in memory/media element 504a. When software is used, any suitable programming, scripting, or other type of language or combinations of languages may be used to implement the teachings contained herein. In other embodiments, the methods disclosed herein may alternatively be implemented by hard-wired logic or other circuitry, including, but not limited to application-specific integrated circuits.

The various memory/media devices of FIG. 5 may be provided as a single portion or multiple portions of one or more varieties of computer-readable media, such as but not limited to any combination of volatile memory (e.g., random access memory (RAM, such as DRAM, SRAM, etc.)) and nonvolatile memory (e.g., ROM, flash, hard drives, magnetic tapes, CD-ROM, DVD-ROM, etc.) or any other memory devices including diskettes, drives, other magnetic-based storage media, optical storage media and others. In some embodiments, at least one memory device corresponds to an electromechanical hard drive and/or or a solid state drive (e.g., a flash drive) that easily withstands shocks, for example that may occur if the electronic device 500 is dropped. Although FIG. 5 shows three separate memory/media devices 504a, 504b and 504c, the content dedicated to such devices may actually be stored in one memory/media device or in multiple devices. Any such possible variations and other variations of data storage will be appreciated by one of ordinary skill in the art.

In one particular embodiment of the present subject matter, memory/media device 504b is configured to store input data received from a user, such as but not limited to data defining a media player interface design area (e.g., size of interface and number, size and/or shape of display elements therein), data defining the one or more actions associated with selected display elements, data defining the one or more action identification labels or media status labels associated with selected display elements, etc. Such input data may be received from one or more integrated or peripheral input devices 510 associated with electronic device 500, including but not limited to a keyboard, joystick, switch, touch screen, microphone, eye tracker, camera, or other device. Memory device 504a includes computer-executable software instructions that can be read and executed by processor(s) 502 to act on the data stored in memory/media device 504b to create new output data (e.g., audio signals, display signals, RF communication signals and the like) for temporary or permanent storage in memory, e.g., in memory/media device 504c. Such output data may be communicated to integrated and/or peripheral output devices, such as a monitor or other display device, or as control signals to still further components.

Referring still to FIG. 5, central computing device 501 also may include a variety of internal and/or peripheral components in addition to those already mentioned or described above. Power to such devices may be provided from a battery 503, such as but not limited to a lithium polymer battery or other rechargeable energy source. A power switch or button 505 may be provided as an interface to toggle the power connection between the battery 503 and the other hardware components. In addition to the specific devices discussed herein, it should be appreciated that any peripheral hardware device 507 may be provided and interfaced to the speech generation device via a USB port 509 or other communicative coupling. It should be further appreciated that the components shown in FIG. 5 may be provided in different configurations and may be provided with different arrangements of direct and/or indirect physical and communicative links to perform the desired functionality of such components.

Various input devices may be part of electronic device 500 and thus coupled to the computing device 501. For example, a touch screen 506 may be provided to capture user inputs directed to a display location by a user hand or stylus. A microphone 508, for example a surface mount CMOS/MEMS silicon-based microphone or others, may be provided to capture user audio inputs. Other exemplary input devices (e.g., peripheral device 510) may include but are not limited to a peripheral keyboard, peripheral touch-screen monitor, peripheral microphone, mouse and the like. A camera 519, such as but not limited to an optical sensor, e.g., a charged coupled device (CCD) or a complementary metal-oxide semiconductor (CMOS) optical sensor, or other device can be utilized to facilitate camera functions, such as recording photographs and video clips, and as such may function as another input device. Hardware components of SGD 500 also may include one or more integrated output devices, such as but not limited to display 512 and/or speakers 514.

Display device 512 may correspond to one or more substrates outfitted for providing images to a user. Display device 512 may employ one or more of liquid crystal display (LCD) technology, light emitting polymer display (LPD) technology, light emitting diode (LED), organic light emitting diode (OLED) and/or transparent organic light emitting diode (TOLED) or some other display technology. Additional details regarding OLED and/or TOLED displays for use in SGD 500 are disclosed in U.S. Provisional Patent Application No. 61/250,274 filed Oct. 9, 2009 and entitled “Speech Generation Device with OLED Display,” which is hereby incorporated herein by reference in its entirety for all purposes.

In one exemplary embodiment, a display device 512 and touch screen 506 are integrated together as a touch-sensitive display that implements one or more of the above-referenced display technologies (e.g., LCD, LPD, LED, OLED, TOLED, etc.) or others. The touch sensitive display can be sensitive to haptic and/or tactile contact with a user. A touch sensitive display that is a capacitive touch screen may provide such advantages as overall thinness and light weight. In addition, a capacitive touch panel requires no activation force but only a slight contact, which is an advantage for a user who may have motor control limitations. Capacitive touch screens also accommodate multi-touch applications (i.e., a set of interaction techniques which allow a user to control graphical applications with several fingers) as well as scrolling. In some implementations, a touch-sensitive display can comprise a multi-touch-sensitive display. A multi-touch-sensitive display can, for example, process multiple simultaneous touch points, including processing data related to the pressure, degree, and/or position of each touch point. Such processing facilitates gestures and interactions with multiple fingers, chording, and other interactions. Other touch-sensitive display technologies also can be used, e.g., a display in which contact is made using a stylus or other pointing device. Some examples of multi-touch-sensitive display technology are described in U.S. Pat. No. 6,323,846 (Westerman et al.), U.S. Pat. No. 6,570,557 (Westerman et al.), U.S. Pat. No. 6,677,932 (Westerman), and U.S. Pat. No. 6,888,536 (Westerman et al.), each of which is incorporated by reference herein in its entirety for all purposes.

Speakers 514 may generally correspond to any compact high power audio output device. Speakers 514 may function as an audible interface for the speech generation device when computer processor(s) 502 utilize text-to-speech functionality. Speakers can be used to speak the messages composed in a message window as described herein as well as to provide audio output for telephone calls, speaking e-mails, reading e-books, and other functions. Speech output may be generated in accordance with one or more preconfigured text-to-speech generation tools in male or female and adult or child voices, such as but not limited to such products as offered for sale by Cepstral, HQ Voices offered by Acapela, Flexvoice offered by Mindmaker, DECtalk offered by Fonix, Loquendo products, VoiceText offered by NeoSpeech, products by AT&T's Natural Voices offered by Wizzard, Microsoft Voices, digitized voice (digitally recorded voice clips) or others. A volume control module 522 may be controlled by one or more scrolling switches or touch-screen buttons.

The various input, output and/or peripheral devices incorporated with SGD 500 may work together to provide one or more access modes or methods of interfacing with the SGD. In a “Touch Enter” access method, selection is made upon contact with the touch screen, with highlight and bold options to visually indicate selection. In a “Touch Exit” method, selection is made upon release as a user moves from selection to selection by dragging a finger as a stylus across the screen. In a “Touch Auto Zoom” method, a portion of the screen that was selected is automatically enlarged for better visual recognition by a user. In a “Scanning” mode, highlighting is used in a specific pattern so that individuals can use a switch (or other device) to make a selection when the desired object is highlighted. Selection can be made with a variety of customization options such as a 1-switch autoscan, 2-switch directed scan, 2-switch directed scan, 1-switch directed scan with dwell, inverse scanning, and auditory scanning. In a “Joystick” mode, selection is made with a button on the joystick, which is used as a pointer and moved around the touch screen. Users can receive audio feedback while navigating with the joystick. In an “Auditory Touch” mode, the speed of directed selection is combined with auditory cues used in the “Scanning” mode. In the “Mouse Pause/Headtrackers” mode, selection is made by pausing on an object for a specified amount of time with a computer mouse or track ball that moves the cursor on the touch screen. An external switch exists for individuals who have the physical ability to direct a cursor with a mouse, but cannot press down on the mouse button to make selections. A “Morse Code” option is used to support one or two switches with visual and audio feedback. In “Eye Tracking” modes, selections are made simply by gazing at the device screen when outfitted with eye controller features and implementing selection based on dwell time, eye blinking or external switch activation.

Referring still to FIG. 5, SGD hardware components also may include various communications devices and/or modules, such as but not limited to an antenna 515, cellular phone or RF device 516 and wireless network adapter 518. Antenna 515 can support one or more of a variety of RF communications protocols. A cellular phone or other RF device 516 may be provided to enable the user to make phone calls directly and speak during the phone conversation using the SGD, thereby eliminating the need for a separate telephone device. A wireless network adapter 518 may be provided to enable access to a network, such as but not limited to a dial-in network, a local area network (LAN), wide area network (WAN), public switched telephone network (PSTN), the Internet, intranet or ethernet type networks or others. Additional communications modules such as but not limited to an infrared (IR) transceiver may be provided to function as a universal remote control for the SGD that can operate devices in the user's environment, for example including TV, DVD player, and CD player.

When different wireless communication devices are included within an SGD, a dedicated communications interface module 520 may be provided within central computing device 501 to provide a software interface from the processing components of computer 501 to the communication device(s). In one embodiment, communications interface module 520 includes computer instructions stored on a computer-readable medium as previously described that instruct the communications devices how to send and receive communicated wireless or data signals. In one example, additional executable instructions stored in memory associated with central computing device 501 provide a web browser to serve as a graphical user interface for interacting with the Internet or other network. For example, software instructions may be provided to call preconfigured web browsers such as Microsoft® Internet Explorer or Firefox® internet browser available from Mozilla software.

Antenna 515 may be provided to facilitate wireless communications with other devices in accordance with one or more wireless communications protocols, including but not limited to BLUETOOTH, WI-FI (802.11 b/g), MiFi and ZIGBEE wireless communication protocols. In general, the wireless interface afforded by antenna 515 may couple the device 500 to any output device to communicate audio signals, text signals (e.g., as may be part of a text, e-mail, SMS or other text-based communication message) or other electronic signals. In one example, the antenna 515 enables a user to use the device 500 with a Bluetooth headset for making phone calls or otherwise providing audio input to the SGD. In another example, antenna 515 may provide an interface between device 500 and a powered speaker or other peripheral device that is physically separated from device 500. The device 500 also can generate Bluetooth radio signals that can be used to control a desktop computer, which appears on the device's display as a mouse and keyboard. Another option afforded by Bluetooth communications features involves the benefits of a Bluetooth audio pathway. Many users utilize an option of auditory scanning to operate their device. A user can choose to use a Bluetooth-enabled headphone to listen to the scanning, thus affording a more private listening environment that eliminates or reduces potential disturbance in a classroom environment without public broadcasting of a user's communications. A Bluetooth (or other wirelessly configured headset) can provide advantages over traditional wired headsets, again by overcoming the cumbersome nature of the traditional headsets and their associated wires.

When an exemplary SGD embodiment includes an integrated cell phone, a user is able to send and receive wireless phone calls and text messages. The cell phone component 516 shown in FIG. 5 may include additional sub-components, such as but not limited to an RF transceiver module, coder/decoder (CODEC) module, digital signal processor (DSP) module, communications interfaces, microcontroller(s) and/or subscriber identity module (SIM) cards. An access port for a subscriber identity module (SIM) card enables a user to provide requisite information for identifying user information and cellular service provider, contact numbers, and other data for cellular phone use. In addition, associated data storage within the SGD itself can maintain a list of frequently-contacted phone numbers and individuals as well as a phone history or phone call and text messages. One or more memory devices or databases within a speech generation device may correspond to computer-readable medium that may include computer-executable instructions for performing various steps/tasks associated with a cellular phone and for providing related graphical user interface menus to a user for initiating the execution of such tasks. The input data received from a user via such graphical user interfaces can then be transformed into a visual display or audio output that depicts various information to a user regarding the phone call, such as the contact information, call status and/or other identifying information. General icons available on SGD or displays provided by the SGD can offer access points for quick access to the cell phone menus and functionality, as well as information about the integrated cell phone such as the cellular phone signal strength, battery life and the like.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A method of providing electronic features for creating a customized media player interface for an electronic device, comprising:
electronically displaying a media player interface design area to a user, wherein a plurality of display elements are placed within the media player interface design area;
in response to one or more electronic input signals from a user, associating selected ones of the plurality of display elements with one or more electronic actions relative to the initiation and control of media files accessible by the electronic device; and
initiating a media player interface on an electronic display apparatus associated with the electronic device, wherein said media player interface comprises media player features corresponding to the plurality of display elements and associated electronic actions.

2. The method of claim 1, further comprising a step in response to one or more additional electronic input signals, of associating labels with selected ones of the plurality of display elements.

3. The method of claim 1, wherein selected labels associated with selected ones of the plurality of display elements comprise labels corresponding to one or more of symbols and text describing the actions associated with a display element.

4. The method of claim 1, wherein selected labels comprise media status labels that identify certain aspects of media file action status, including one or more of a current media file label, current playlist label, media playing status, media shuffle status, and media repeat status.

5. The method of claim 1, wherein said one or more electronic input signals from a user defines one or more of the number of buttons to be placed within the media player interface design area, the size of the buttons to be placed within the media player interface design area, and the relative location of the buttons within the media player interface design area.

6. The method of claim 1, wherein the one or more given actions relative to electronic initiation and control of media files that may be associated with selected of the plurality of display elements comprises one or more of playing, pausing, stopping, adjusting play speed, adjusting volume, adjusting current file position, toggling modes such as repeat and shuffle, establishing a playlist, viewing a playlist, modifying a playlist, and clearing a playlist.

7. The method of claim 1, further comprising a step in response to one or more additional electronic input signals from a user of configuring the electronic device to coordinate playing the audio portion of media files when other audio signals are also to provided as output.

8. The method of claim 1, further comprising a step in response to one or more additional electronic input signals from a user of configuring the electronic device for editing of existing playlist files when new files are added to an existing playlist.

9. The method of claim 1, further comprising a step in response to one or more additional electronic input signals from a user of configuring the electronic device to use specific levels for volume settings associated with the playback of speech signals, audio feedback signals, and media signals.

10. The method of claim 1, further comprising a step in response to one or more additional electronic input signals from a user, of associating selected ones of the plurality of display elements with one or more given electronic actions relative to the communication of speech-generated message output provided by the electronic device.

11. A computer readable medium comprising computer readable and executable instructions configured to control a processing device to:
electronically display a graphical user interface design area to a user, wherein a plurality of display elements are placed within the graphical user interface design area;
in response to one or more electronic input signals from a user, associate selected of the plurality of display elements with one or more given electronic actions relative to the initiation and control of media files accessible by the electronic device;
in response to one or more additional electronic input signals, associate one or more labels with selected ones of the plurality of display elements; and
initiate a graphical user interface on an electronic display apparatus associated with the electronic device, wherein said graphical user interface comprises media player features corresponding to the plurality of display elements and associated electronic actions and labels.

12. The computer readable medium of claim 11, wherein said one or more labels associated with selected ones of the plurality of display elements comprise labels corresponding to one or more of symbols and text describing the actions associated with a display element.

13. The computer readable medium of claim 11, wherein selected labels comprise media status labels that identify certain aspects of media file action status, including one or more of a current media file label, current playlist label, media playing status, media shuffle status, and media repeat status.

14. The computer readable medium of claim 11, wherein said one or more electronic input signals from a user defines one or more of the number of buttons to be placed within the media player interface design area, the size of the buttons to be placed within the media player interface design area, and the relative location of the buttons within the media player interface design area.

15. The computer readable medium of claim 1, wherein said one or more given actions relative to electronic initiation and control of media files that may be associated with selected of the plurality of display elements comprises one or more of playing, pausing, stopping, adjusting play speed, adjusting volume, adjusting current file position, toggling modes such as repeat and shuffle, establishing a playlist, viewing a playlist, modifying a playlist, and clearing a playlist.

16. An electronic device, comprising:
at least one electronic output device configured to display a graphical user interface design area to a user, wherein a plurality of display elements are placed within the graphical user interface design area;
at least one electronic input device configured to receive electronic input from a user corresponding to data for defining one or more of the number of display elements to be placed within the graphical user interface design area, the size of the display elements to be placed within the graphical user interface design area, the relative location of the display elements within the graphical user interface design area, one or more electronic actions relative to the initiation and control of media files accessible by the electronic device for association with selected display elements, and one or more action identification labels or media status labels for association with selected display elements;
at least one processing device;
at least one memory comprising computer-readable instructions for execution by said at least one processing device, wherein said at least one processing device is configured to receive the electronic input defining the various features of the graphical user interface and to initiate a graphical user interface having such features.

17. The electronic device of claim 16, wherein said electronic device comprises a speech generation device that comprises at least one speaker for providing audio output, and wherein said at least one processing device is further configured to associate selected ones of the plurality of display elements with one or more given electronic actions relative to the communication of speech-generated message output provided by the electronic device.

18. The electronic device of claim 16, wherein the one or more given actions relative to electronic initiation and control of media files that may be associated with selected of the plurality of display elements comprises one or more of playing, pausing, stopping, adjusting play speed, adjusting volume, adjusting current file position, toggling modes such as repeat and shuffle, establishing a playlist, viewing a playlist, modifying a playlist, and clearing a playlist.

19. The electronic device of claim 16, wherein said at least one processing device is further configured to operate the electronic device in accordance with additional input signals received from a user defining how to configure the electronic device for playing the audio portion of media files when other audio signals are also to provided as output.

20. The electronic device of claim 16, wherein said at least one processing device is further configured to operate the electronic device in accordance with additional input signals received from a user defining how to configure the electronic device for editing existing playlist files when new files are added to an existing playlist.

21. The electronic device of claim 16, wherein said at least one processing device is further configured to operate the electronic device in accordance with additional input signals received from a user defining specific levels for volume settings associated with the playback of speech signals, audio feedback signals, and media signals.
